(19) United States
(12) Patent Application Publication
(10) Pub. No.: US 2006/0261172 A1
(43) Pub. Date: Nov. 23, 2006

(54) GARAGE SALE LABEL SYSTEM AND METHOD

(76) Inventor: Frances Maxine Dougherty Tims, Haltom City, TX (US)

Correspondence Address: GUY V. MANNING, 1407 TEXAS STREET, SUITE 102, FORT WORTH, TX, 76102, US

(21) Appl. No.: 11/419,119

(22) Filed: May 18, 2006

Related U.S. Application Data
(60) Provisional application No. 60/682,300, filed on May 18, 2005.

(51) Int. Cl. G06K 19/00; G06F 17/00

(52) U.S. Cl. 235/487; 235/375

(57) ABSTRACT

A system for garage sale pricing includes labels bearing preprinted prices in various price ranges. The labels may be used as is, but they also include a space adjacent the pre-printed unit price for a fractional increment of the unit price to be entered if desired. The labels further may include spaces for marking lot numbers, sizes and ownership indicia for distinguishing between vendors. The labels are arrayed onto sheets with labels of various prices common to garage sales, or provided in strips rolled up for use in a dispenser. The adhesive on the labels allows removal from most surfaces without damage thereto, the adhesive remaining effective enough for replacement on other objects. A tally board is included for accumulating each vendor's labels separately to assist in reconciliation of sale revenues.

### BACKGROUND OF THE INVENTION

1. Field of the Invention

This invention relates generally to the practice of conducting garage sales, and particularly to the labeling of diverse items displayed for sale. More particularly, this invention relates to a system and method for tailoring pre-priced labels to the items displayed.

2. Description of Related Art

The garage sale phenomenon ever increases in popularity as people sell their no-longer-needed belongings to others who shop at such sales to acquire items a prices considered bargains. Through garage sales, vendors recycle used items, effectively extending their usable life for others to enjoy, while earning extra income. The term “garage sale” as used herein includes any resale of used household items, often in an informal, temporary setting such as someone's garage, yard or home. Such sales also are known by other names such as rummage sales, estate sales, yard sales, moving sales, flea markets, school craft sales, antique malls and craft malls. The term typically does not include sales of new items in retail stores, though this invention just as easily could be utilized by such retailers.

The most time consuming and tedious aspect of garage sales is pricing the merchandise. If each item is not individually marked, vendors may spend substantial time answering inquiries about price and other characteristics of the diverse merchandise. They also risk inconsistency and lost revenues when attempting to determine the price of an item on the spot. Where multiple families or individuals contribute items for sale in a single garage sale, accounting for proceeds due to each is one of the most complicated aspects of the sale. A need exists for easing the burden of pricing garage sale merchandise and for simplifying accounting for sales by different vendors through a common outlet such as multifamily garage sales.

Stick on labels for retail sales are common. Because unscrupulous shoppers can replace higher price labels with those from less expensive items, retailing labels typically are not easily removed intact, either because the adhesive is too strong or the labels perforated so they will be destroyed by attempts to remove them. In the garage sale context, labels which adhere tenaciously are undesirable because, unlike retailing where the labels usually appear on packaging, garage sales labels usually are placed directly onto the merchandise itself. If labels are difficult to remove, they can mar or damage the items. Further, garage sale merchandise often appears in multiple sales over time, and pricing can become obsolete and need replacing (this is more typical of flea markets and antique malls than the typical garage sale). A need exists for labels which easily may be removed without harming merchandise.

Prior art labeling systems emphasize pre-printed prices on pressure-sensitive labels usually bearing set prices in common denominations such as $ 0.25, $ 0.50, $ 0.75, $ 1.00, $ 2.00 and the like. Such pre-printed fixed labels usually offer no means for tailoring prices precisely. To price an item at an odd price, such as $ 1.37, blank labels may be included in a package to supplement the pre-printed ones. Blank labels, however, vitiate the advantage of pre-printed labels. Further, packaged selections of labels bearing fixed, pre-printed prices often include too many of one price and not enough of others, causing waste and increased purchases of packages of such pre-printed labels in order to obtain enough of certain prices. A need exists for pre-printed labels which accommodate specialized, tailored prices.

### SUMMARY OF THE INVENTION

Accordingly, it is an object of this invention to provide a selection of labels for easy pricing and otherwise marking merchandise for garage sales.

It is another object of this invention to provide means for efficiently accounting for proceeds between multiple vendors at garage sales.

It is another object of this invention to provide labels which efficiently may be removed and accumulated for accounting purposes.

It is another object of this invention to provide labels which will not harm merchandise upon which they are affixed directly.

The foregoing and other objects of this invention are achieved by providing garage sale pricing labels bearing preprinted prices in various price ranges. The labels may be used as is, but they also include a space adjacent the pre-printed unit price for a fractional increment of the unit price to be entered if desired. The labels further may include spaces for marking lot numbers, sizes and ownership indicia for distinguishing between vendors. The labels are arrayed onto sheets with labels of various prices common to garage sales, or provided in strips rolled up for use in a dispenser. The adhesive on the labels allows removal from most surfaces without damage thereto, the adhesive remaining effective enough for replacement on other objects. A tally board is included for accumulating each vendor's labels separately to assist in reconciliation of sale revenues.

### BRIEF DESCRIPTION OF THE DRAWINGS

The novel features believed characteristic of the present invention are set forth in appended claims. The invention itself, however, as well as a preferred mode of use and further objects and advantages thereof, will best be understood by reference to the following detailed description of an illustrative embodiment when read in conjunction with the accompanying drawings, wherein:

FIG. 1 depicts a row of labels bearing preprinted monetary units and spaces for entering a fraction thereof, as well as ownership and characteristic indicia.

FIG. 2 shows a cross section of a row of labels such as those depicted in FIG. 1, with the different layers of the invention displayed.

FIG. 3 depicts a garage sale item with a label affixed.

FIG. 4 shows a sheet of labels all bearing like prices.

FIGS. 5A and 5B show labels bearing a variety of different pre-printed prices arrayed in rows on a single sheet.

FIG. 6 depicts a dispenser of labels disposed in a single row on a rolled tape.

FIG. 7 shows a tally board bearing ownership regions and labels arrayed thereon according to ownership information.

### DETAILED DESCRIPTION OF A PREFERRED EMBODIMENT

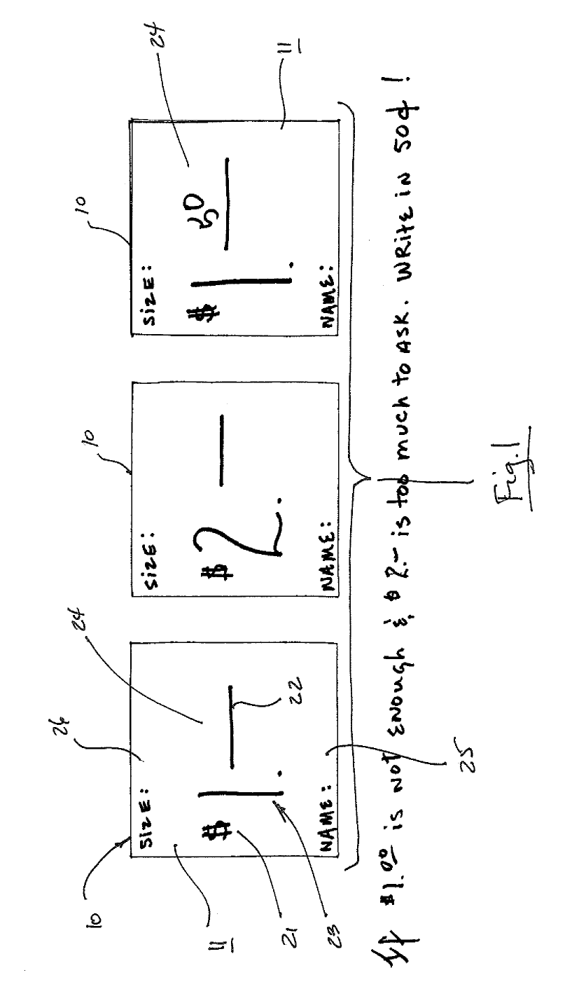

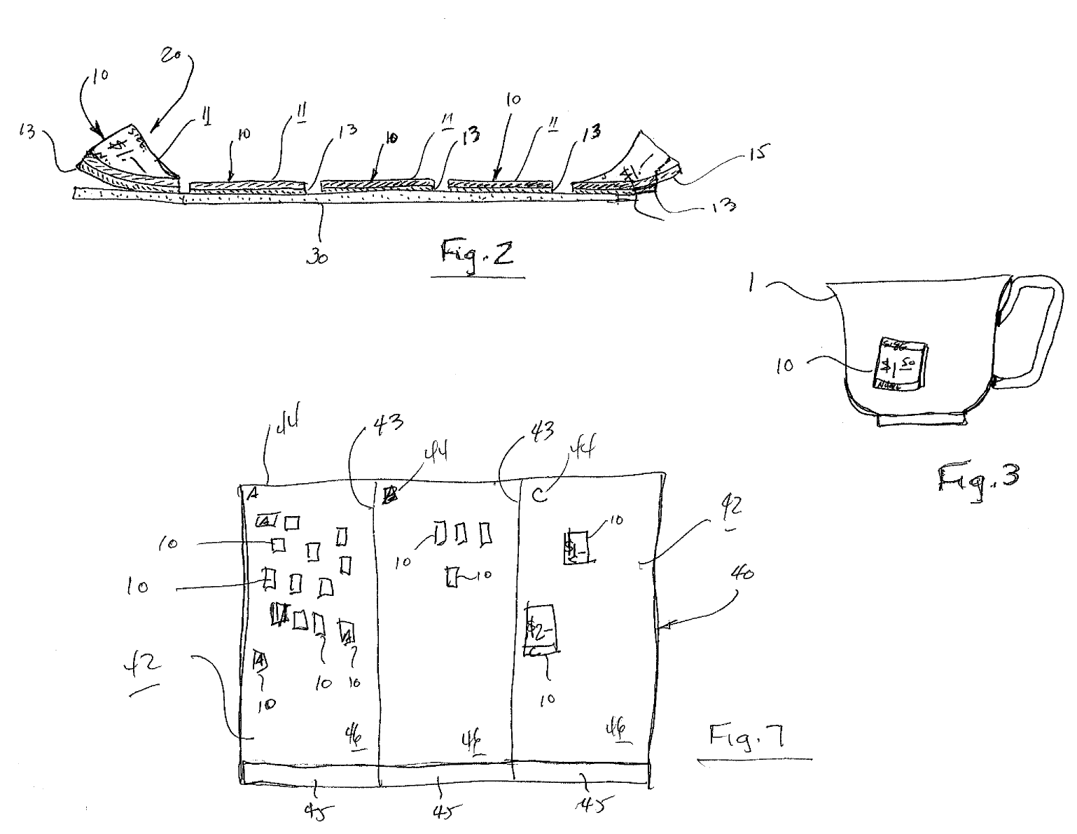

With reference now to the figures, and in particular to FIGS. 1-5B, labels 10 comprise what is commonly known as self-adhesive or pressure-sensitive tags made up of a shaped portion of paper having front printable surface 11 opposite rear surface 12 bearing adhesive layer 13 affixed to backing 30 from which labels 10 easily may be peeled off for placing on merchandise 1. Labels 10 may be of any shape, such as circles, ovals, stars or the like, but preferably for garage sale purposes labels 10 are rectangular in shape, and more preferably they are square.

Borne on printable surface 11 of labels 10 are three regions of interest. Preferably centered within printable surface 11, and occupying a substantial percentage thereof, message 20 is pre-printed onto label 10 preferably using visible ink, graphite or the like such that it easily may be read without the aid of machine, chemical or magnification. One having ordinary skill in the art will recognize that other forms of impressing message 20 onto surface 11 may be utilized, such as embossing or imprinting in Braille (neither shown) without departing from the spirit and scope of the present invention. Each message 20 comprises a price selected from an array of unit prices appropriate for the garage sale context, typically having small denominations such as $ 0.25, $ 0.50, $ 0.75, $ 1.00, $ 2.00 and the like.

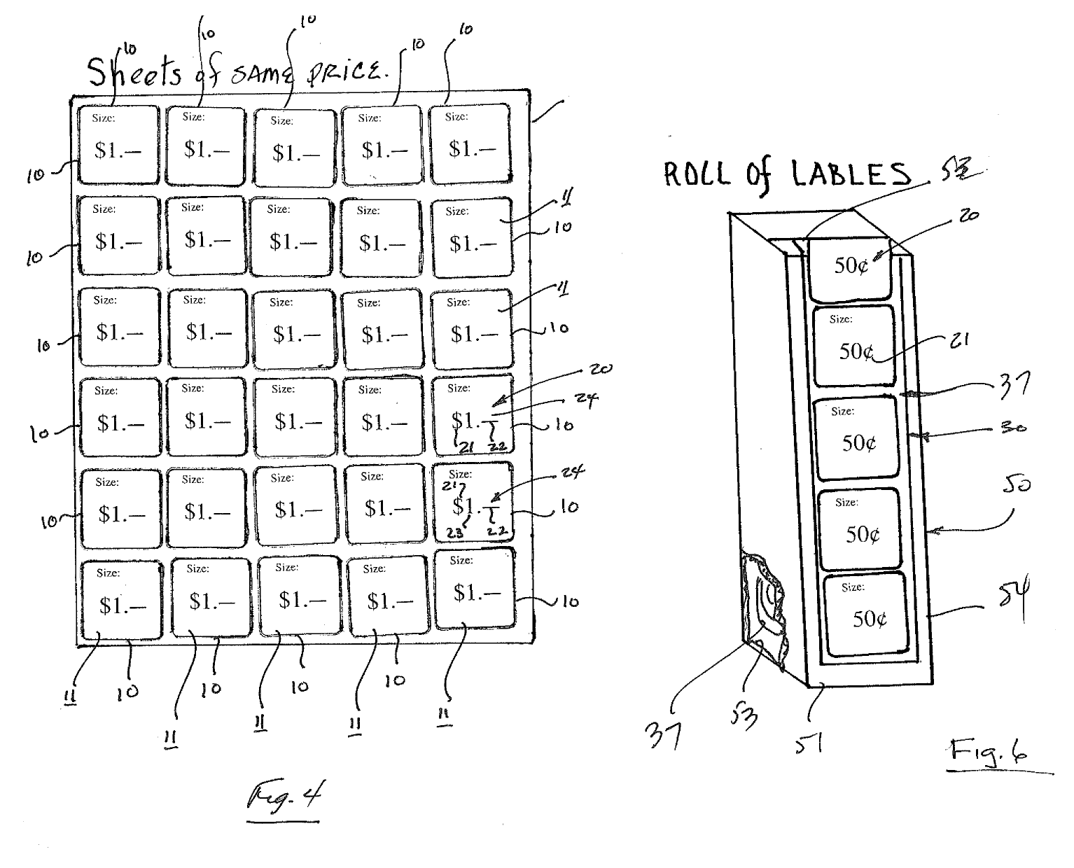

The price portion of message 20 comprises several parts. Unit symbol 21 indicates the monetary unit of value to be assigned to garage sale item 1 by a given label 10. Monetary unit symbol 21 in such case will be that symbol commonly used for representing whole and fractional currency, such as a dollar, pound sterling for whole units, and pence, cents or the like for fractions thereof. Adjacent symbol 21 appears pre-printed price numeral 23 comprising all or a portion of the price to be assigned to sale item 1. As seen particularly in FIGS. 4 and 5B, adjacent numeral 23 may appear fraction demarcation symbol 22, comprising a decimal point or underline adapted to separate and distinguish a representation of a fractional portion of monetary unit 21 to be included into the assigned price for item 1.

Juxtaposed demarcation symbol 22, fractional space 24 is provided for manually filling in said fractional portion of monetary unit 21 if desired. Where no fractional portion of monetary unit 21 is written into space 24, the price represented on label 10 will be a whole multiple of monetary unit 21 indicate by numeral 23. As will be understood, and as represented particularly in FIG. 5A, some labels 10 may include numerals 23 which themselves are fractional values of a whole unit of currency. Advantageously, then, labels 10 may include fully pre-printed prices or they may include pre-printed numerals 23 as portions thereof with fraction space 24 for the owner of item 1 to fill in an increment thereto should a more precise asking price be desired.

Disposed above and below price message 20, spaces 25, 26 are reserved for additional indicia about item 1. Significantly, ownership space 25 provides a place for the owner of item 1 to enter a name, number or other code signifying her ownership of item 1. This information is important later for reconciling revenues among multiple vendors in a multi-vendor sale, as discussed in more detail below.

Characteristic space 26 disposed adjacent price message 20 opposite ownership space 25 provides an area for indicating one or more important characteristics of item 1. For example, it may indicate size (for clothing, shoes, etc.), age, material (e.g. porcelain), date manufactured, manufacturer, or any other characteristic of interest to potential buyers of item 1. Entering information in characteristic space 26 may save the owner significant time and trouble explaining such characteristics to buyers. Beyond such immediate sales enhancement, the information entered into characteristic space 26 could include other identifying indicia recognizable only to the owner, such as a code for the owner's investment in item 1, should a buyer wish to haggle about the price thereof. One having ordinary skill in the art will recognize that the exact configurations and locations of characteristic space 26 and ownership space 25 may vary considerably, including their inclusion or omission from label 10, without departing from the spirit and scope of the present invention.

Adhesive layer 13 comprises one of a variety of adhesive laminates commonly known in the art and having the characteristic of adhering permanently to rear surface 12 of label 10 while removably adhering to adherent surface 35 of sheets 30 and to sale item 1. Adhesive layer 13 thus will be manufactured to bond permanently to rear surface 12 but to retain sufficient adhesion to removably stick to a variety of surfaces such as wood, metal, ceramic, cloth, paper and the like without bonding with said surfaces or reacting with any finish which may appear thereon. Thus, adhesive layer 13 remains affixed to rear surface 12 even when removed from other surfaces repeatedly, yet retains sufficient adhesive qualities to be re-adhered to such other surfaces indefinitely.

Sheet 30 preferably comprises a flexible, planar web in one of a variety of shapes, but preferably comprises a rectangular sheet having at least one adherent surface 35 upon which labels 10 are arrayed in one or more rows. Sheets 30 preferably comprise 15 or 20 pound bond paper coated at least one side (surface 35) with a thin layer of polyethylene laminate to prevent adhesive layer 13 from bonding to sheet 30 over time. Sheets 30 preferably are selected in length and width to accommodate a plurality of labels 10 arrayed in at least one row and preferably multiple rows of several labels 10 in length. Sheets 30 preferably contain a convenient number of labels 10, such as 20 or thirty per sheet 30, and preferably sheets 30 are rectangular and of a convenient size to fit into a typical notebook, pocket or purse for transportation and storage by the owner. A small space may be provided between labels 10 to facilitate removal of each label 10 without disturbing the others.

As best seen in FIGS. 5A, 5B, the system of the present invention may incorporate a plurality of sheets 30 bearing different denominations of price messages 20 commonly used at garages sales. A package (not shown) of labels 10 may include multiple sheets of a single price (FIG. 4) or sheets 30 bearing different prices (FIGS. 5A, 5B). One having ordinary skill in the art will recognize that any combination of such sheets may be included in a single package without departing from the spirit and scope of the present invention.

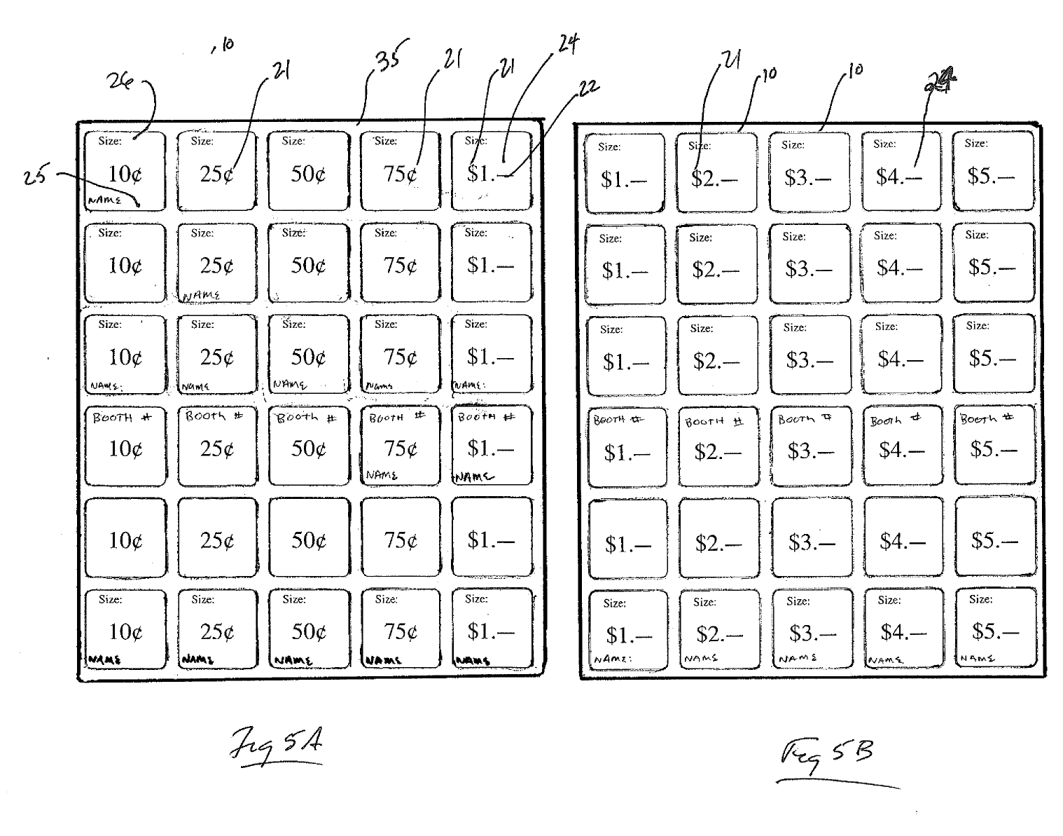

Turning now to FIG. 6, a dispenser for labels 10 comprises hollow box 51 surrounding and containing a roll of tape 37 bearing a single row of labels 10. Tape 37 protrudes through slot 53 of box 51 to present labels 10 one at a time for completion and removal for attachment to item 1. Box 51 is shaped conveniently for holding in the owner's hand while she proceeds from one garage sale item 1 to the next throughout the garage sale area (not shown). Front surface 54 provides a convenient bearing surface against which labels 10 may be pressed while the owner writes on them to complete price, ownership and characteristic information as needed for item 1. Once labels 10 are completed, they are peeled off for placement onto item 1. The exposed portion of backing 30 may be torn off and discarded and the remainder of tape 37 conveniently stored inside box 51 for later extraction through slot 53 and use.

Turning now to FIG. 7, tally board 40 comprises backing 41 having tally surface 42 divided into a plurality of conveniently sized ownership regions 46 by dividers 43. Ownership designations 44 appear in convenient and preferably consistent locations within each region 46 to distinguish one owner's region 46 from that of another. Summary space 45 disposed near the bottom of each region 46 provides an area for writing subtotals and notes. As depicted, labels 10 bearing ownership indicia within ownership space 25 of message 20 are assembled onto tally board 40 according to which region 46 is assigned to each owner. Upon completion of a garage sale, tally board 40 thus represents graphically the sales of items 1 by each owner. Such sales may be subtotaled by regions 46 to determine an allocation factor for actual revenues as follows.

Labels 10 placed into each owner's region 46 on tally board 40 are summed according to their face value as indicated in price message 20 to arrive at a subtotal of all labels 10. Subtotals then are written within summary space 45, and all subtotals are added together to arrive at a total sales amount. Each region 46 subtotal then is divided by the total sales amount to arrive at a percentage of total sales credited to each owner. Actual revenues, as represented by the sum of all checks, credit card invoices and cash, preferably collected and accumulated in a cash box or register (not shown), are multiplied by each percentage to determine the actual revenues to be distributed to each owner. The following example illustrates this process:

CHART I

| | (A) | (B) | (C) |
|---|---|---|---|
| | Tally board | Percent | Cash box |
| | subtotals | by region | revenues |
| Region A | $140.00 | .20 | $142.20 |
| Region B | 210.00 | .30 | 213.30 |
| Region C | 350.00 | .50 | 355.50 |
| Totals | $700.00 | 1.00 | $711.00 |

In Chart I, actual revenues of $ 711.00 in Column C are allocated to Regions A-C based on their respective percentages in Column B of tally board subtotals in Column A.

The total from tally board 40 also is useful to compare to the sum of actual revenues to determine if there is enough disparity between the two amounts (Totals of Column A versus Column C) to justify a recount of one or the other of labels 10 by regions 46 or actual revenues in the cash box, or both. If the difference is minor (only $ 11.00 in the example of Chart I above), the percentages from tally board 40 represent a realistic allocation factor for revenues between owners. If the totals are widely different, this suggests that an error has occurred in one or both calculations, justifying a recount.

The present invention, described in either its preferred or alternate embodiment, thus serves as means for easing the tediousness and burden of pricing each item 1 for a garage sale, as well as means for totaling revenues from such sales. Where multiple owners participate in a single garage sale, ownership indicia on labels 10 may be correlated with owner regions 46 on tally board 40 to facilitate a final tally by owner of revenues for the day. If the garage sale extends to more than one day, labels 10 accumulated on tally board 40 the first day may be removed and discarded to provide for a separate tally by owner for each day, or they may be left in place for subtotaling and allocation of revenues for all days.

While the invention has been particularly shown and described with reference to one or more embodiments, it will be understood by those skilled in the art that various changes in form and detail may be made therein without departing from the spirit and scope of the invention. For example, labels 10 have been depicted and discussed as having a distinct adhesive layer 13 bonded to rear surface 12 with labels 10 comprising bond paper, but labels 10 could comprise a flexible thermoplastic material such as polyethylene having static bonding characteristics whereby no adhesive is needed for adhering labels 10 to most surfaces. This works well for smooth surfaces of item 1 such as metal, ceramic and glass, but not as well for rough surfaces such as wood or cloth. Nevertheless such materials for labels 10 are considered an aspect of the present invention. Also, labels 10 have been discussed as having an explicit ownership space 25 pre-printed onto surface 11, but ownership could be signified by color coding labels 10, either in solid colors or in colored borders, hatching or the like, thereby leaving more space for characteristic space 26 and or price message 20. Also, adhesive layer 13 may cover only a portion of rear surface 12, thereby leaving a free portion of label 10 free of adherent surface 35 for ease of lifting and removing it. A convenient free portion may be one corner of label 10.

I claim:

1. A system for pricing goods comprising
a backing layer;
a self-adhesive label having a length and a width and adapted to removably attach to the goods, the label having
a printable surface;
a back surface opposite the printed surface;
adhesive means for adhering the label to the goods; and
a printed price disposed onto the printable surface in visible media, the price having
a symbol signifying a standard unit of money;
a numeral disposed juxtaposed the symbol for indicating a nominal base amount for the printed price;
fraction demarcation means associated with the numeral for indicating a fractional increment to the numberal; and
a fraction space disposed adjacent the fraction demarcation menas opposite the numeral for manual entry a fractional portion of the standard unit of money.

2. The pricing system according to claim 1 wherein the backing layer comprises
a flexible web having
a web length substantially equal to at least one multiple of the label length; and
a web width substantially equal to at least one multiple of the label width; and
an adherent surface adapted to removably receive at least one label affixed thereto by the adhesive means.

3. The pricing system according to claim 2 wherein the adhesive means comprises
an adhesive layer bonded to the back surface.

4. The pricing system according to claim 1 wherein the fractional demarcation means comprises
a line underscoring the fraction space.

5. The pricing system according to claim 1 wherein the fractional demarcation means comprises
a decimal symbol disposed between the numeral and the fraction space.

6. The pricing system according to claim 5 wherein
the labels are rectangular.

7. The pricing system according to claim 1 wherein
a portion of the rear surface of each of the labels is free of the adhesive means.

8. The pricing system according to claim 7 wherein the portion of the rear surface that is free of the adhesive means comprises
one corner of the labels.

9. The pricing system according to claim 8 wherein
the adhesive means covers at least 90 percent of the rear surface.

10. The pricing system according to claim 1 and further comprising
a pre-printed characteristic space provided adjacent the pre-printed price.

11. The pricing system according to claim 1 and further comprising
a pre-printed ownership space provided adjacent the pre-printed price.

12. The pricing system according to claim 11 and further comprising
a pre-printed characteristic space provided adjacent the pre-printed price.

13. The pricing system according to claim 12 wherein
the backing layer comprises a rolled tape having a single row of labels; and
the system further comprising a box adapted to contain the rolled tape and having
an interior and an exterior surface;
a slot for communicating between the interior and the exterior surface whereby the rolled tape may be extended outside the box; and
a writing surface disposed on the outside of the box whereon the labels may be supported while they are marked upon.

14. A system for providing self-adhesive labels for pricing goods, the system comprising
a plurality of backing layers, each backing layer having
a length substantially equal to at least one multiple of a label length; and
a width substantially equal to at least one multiple of a label width; and
an adherent surface adapted to removably receive a plurality of labels affixed thereto; and
a plurality of self-adhesive labels disposed in a regular array on the adherent surface, the array having at least one row parallel the backing layer length, each label having
a printable front surface and a rear surface opposite the front surface;
a label length substantially an even fraction of the length of the backing layer;
a label width substantially an even fraction of the width of the backing layer;
an adhesive layer disposed on a portion of the rear surface and adapted to removably attach the label to the adherent surface and to the goods, the label having
a pre-printed price disposed on the printable front surface, the price having
a symbol signifying a standard unit of money;
a numeral disposed juxtaposed the symbol for indicating a nominal base amount for the printed price;
a decimal associated with the numeral; and
a space disposed adjacent the decimal opposite the numeral for manual entry of a fractional portion of the standard unit of money
a pre-printed ownership space disposed on the printable front surface adjacent the pre-printed price; and
a pre-printed characteristic space disposed on the printable front surface adjacent the pre-printed price and opposite the ownership space.

15. The pricing system according to claim 14 wherein
the array of labels comprises a plurality of rows and columns; and
the backing layer comprises a rectangular sheet adapted to be packaged in substantially flat displays of multiple backing layers.

16. The pricing system according to claim 14 wherein
the backing layers comprise a plurality of rolled tape having a single row of labels; and
the system further comprises at least one box adapted to contain one rolled tape and having
an interior and an exterior surface;
a slot for communicating between the interior and the exterior surface whereby the rolled tape may be extended outside the box; and
a writing surface disposed on the outside of the box whereon the labels may be supported while they are marked upon.

17. An improved method of pricing garage sale items for a garage sale conducted by multiple owners of garage sale items, the method comprising
providing a plurality of sheets of self-adhesive pricing labels, each sheet having
a plurality of self-adhesive labels removably disposed on a backing layer, each label adapted to removably attach to the goods having
a length, a width, a printable front surface and a back surface opposite the printed surface;
adhesive means adapted to adhere the label to the goods;
a pre-printed price disposed on the printable surface, the price having
a symbol signifying a standard unit of money;
a numeral disposed juxtaposed the symbol for indicating a nominal base amount for the pre-printed price;
a decimal associated with the numeral; and
a space disposed adjacent the decimal opposite the numeral for manual entry a fractional portion of the standard unit of money
a pre-printed ownership space disposed on the printable front surface adjacent the pre-printed price; and
a pre-printed characteristic space disposed on the printable front surface adjacent the pre-printed price and opposite the ownership space; and
providing a tally board having an tally board adherent layer adapted to receive the labels; then
(a) entering a fractional portion on selected labels;
(b) removing each label and attaching it to an item; then
(c) collecting from a buyer of each item the sum of the nominal base amount and the fractional portion; then
(d) removing the label from the item and affixing it to the tally board; then
(e) repeating steps (a) through (d), inclusive, for each item in the garage sale; then
(f) distributing revenues from the sale according to the sum of labels on the tally board.

18. The improved method of claim 17 and further comprising the steps of
dividing the tally board into regions associated with each owner;
between steps (a) and (b), entering an ownership indicia into the according to ownership of the item; then
as part of step (d), determining which region of the tally board is associated with the ownership indicia on the label and affixing it to the tally board within that region; then
summing the labels of each region of the tally board to determine a subtotal for each region; and
summing the subtotals to calculate a total; then
dividing each subtotal by the total to determine a percentage of sales revenues for each owner; then
as part of step (f), distributing revenues to each owner according to the percentages.

19. The pricing system according to claim 18 wherein
the backing layer comprises a rolled tape having a single row of labels; and
the system further comprising a box adapted to contain the rolled tape and having
an interior and an exterior surface;
a slot for communicating between the interior and the exterior surface whereby the rolled tape may be extended outside the box; and
a writing surface disposed on the outside of the box whereon the labels may be supported while the fractional portions are entered in step (a) and the ownership indicia are entered between steps (a) and (b).
